(19) United States
(12) Patent Application Publication
(10) Pub. No.: US 2007/0042743 A1
(43) Pub. Date: Feb. 22, 2007

(54) FREQUENCY CHANGER AND TUNER

(76) Inventors: Isaac Ali, Bristol (GB); Nicholas Paul Cowley, Wiltshire (GB)

Correspondence Address: PATTERSON & SHERIDAN, L.L.P., 3040 POST OAK BOULEVARD, SUITE 1500, HOUSTON, TX, 77056, US

(21) Appl. No.: 11/464,573

(22) Filed: Aug. 15, 2006

(30) Foreign Application Priority Data
Aug. 16, 2005 (GB) 0516766.3

(51) Int. Cl. H04B 1/26

(52) U.S. Cl. 455/313

(57) ABSTRACT

A frequency changer for a radio frequency tuner and a tuner incorporating such a frequency changer are provided. The frequency changer comprises a mixer comprising a plurality of mixing stages. The output signals of these stages are supplied without relative phase shift to a summer, for example, in the form of a common load arrangement. The inputs of the stages are connected together to form a signal input of the mixer. Commutating signal inputs of the mixing stages received from the local oscillator are of the same frequency, but of different phases. The commutating signals are square or rectangular waves.

### CROSS-REFERENCE TO RELATED APPLICATION

This application claims priority to British Patent Application Serial Number GB 0516766.3, filed Aug. 16, 2005, which is herein incorporated by reference.

### BACKGROUND OF THE INVENTION

1. Field of the Invention

Embodiments of the present invention relate to a frequency changer for a radio frequency tuner and to a tuner including such a frequency changer. Such a tuner may be used, for example, for receiving digital or analog broadcast signals from a terrestrial aerial, a satellite aerial system or a cable distribution system. Such a tuner may be used, for example, for receiving digital television signals, digital audio broadcast signals, telephony or data signals.

2. Description of the Related Art

Known types of radio frequency tuners comprise one or more frequency changers for converting a desired channel from a broadband input spectrum to a predetermined intermediate frequency. A typical broadband spectrum comprises the frequency range from 50 to 860 MHz and the selected channel may be converted to a “classical” intermediate frequency, typically between 30 and 50 MHz, a first high intermediate frequency, typically on the order of 1.1 GHz, zero intermediate frequency (ZIF), or near zero intermediate frequency (NZIF). The frequency changer comprises one or more mixers receiving commutating signals from a variable local oscillator having a frequency range equal to the broadband frequency range plus or minus the intermediate frequency. The commutating signals supplied by the local oscillator to the or each mixer are typically rectangular or square waves having relatively steep rising and falling edges so as to perform “hard switching” in a switching cell of the or each mixer, which is typically embodied as a Gilbert cell.

The use of hard switching in the mixer cell has known advantages. For example, the transitors in the mixer cell are switched rapidly between their extreme conductive and non-conductive states and spend relatively little time in their linear amplifying states. Also, distortion products are reduced as compared with soft switching, for example, by means of a commutating signal comprising a sine wave.

In order to select a desired channel, the fundamental frequency of the square wave commutating signal is controlled so as to be equal to the intermediate frequency plus or minus the centre frequency of the desired channel. In the case of ZIF, the local oscillator frequency is equal to the centre frequency of the desired channel.

The square wave commutating signal contains additional frequency components resulting in harmonic mixing of undesired channels or noise, which becomes superimposed on the desired channel at the intermediate frequency. In particular, the square wave theoretically contains all odd harmonics of the fundamental frequency with the amplitude of each harmonic component reducing as the order of the harmonic component increases. The harmonic content of a perfect square wave (to the thirteenth harmonic) is as follows:

| Harmonic | Relative Amplitude (dBc) |
|---|---|
| 1 | 0 |
| 3 | −9.54 |
| 5 | −13.98 |
| 7 | −16.9 |
| 9 | −19.09 |
| 11 | −20.83 |
| 13 | −22.28 |

Thus, any undesired signal or noise at the input of the mixer in a channel centred on a frequency F_{DN} given by:
F_{DN}=F_{LO}×((2 ×N)+1)±F_{IF}
where N is an integer greater than zero, F_{LO} is the frequency of the local oscillator and F_{IF} is the intermediate frequency, will be converted to the output intermediate frequency passband so as to be superimposed on the desired channel.

Frequency changers which are not of the ZIF type also convert the “image” channel to the intermediate frequency. The frequency of the image channel is on the opposite side of the local oscillator frequency from the frequency of the desired channel and is spaced from the frequency of the desired channel by twice the intermediate frequency. Image channels are also converted by the harmonic mixing process, as is implicit in the above expression.

The presence of harmonic components of order greater than one in a square wave commutating signal thus has the potential for converting undesired signals and noise to the output intermediate frequency passband. For example, in the case of a broadband input spectrum covering several octaves, there may be occupied channels at the frequencies which are converted to the intermediate frequency passband so that the desired channel may be contaminated with interfering channels and noise such that acceptable reception cannot be achieved. Because the interfering signals and noise are within the intermediate frequency passband, intermediate frequency or subsequent filtering cannot be used to remove the interfering signals or noise.

Image-cancelling mixers are known in which substantial reduction or cancellation of the image channel is provided. Such image-cancelling mixers are particularly useful in the case of NZIF frequency changers, where the image channel is immediately adjacent the desired channel so that the image channel cannot be sufficiently filtered out or attenuated by filtering ahead of the frequency changer.

It is also known to provide tracking filters ahead of all types of frequency changers. The passband of such radio frequency tracking filters tracks the frequency of the desired channel so that the filter attenuates channels sufficiently far from the desired channel for the filtering to have an effect. In conventional or classical intermediate schemes, this filtering provides attenuation to the image channel.

Such filtering and image-cancelling techniques may be used to provide acceptable performance with various intermediate frequency schemes. However, in order to provide sufficient protection against interference, such tracking radio frequency filters are required to be of relatively high performance. Such filters cannot be formed in a monolithic integrated circuit. The filters are therefore formed as external components, which add substantially to the cost of manufacturing tuners. Further, in order to provide adequate performance, multi-section filters (comprising a plurality of inductance/capacitance sections) frequently have to be provided. As is well known, such filters have to be set during an alignment operation of the tuner during manufacture in order to ensure that the filter passbands track the local oscillator frequency (with the appropriate offset as necessary) sufficiently well across the tuning range of the tuner for adequate reception performance to be achieved. Again, such alignment adds substantially to the cost of manufacturing a tuner.

U.S. published Patent Application 2004/0127187 discloses a quadrature frequency converter for avoiding the use of two independent transconductance stages in I and Q Gilbert cells. The transconductance stages are replaced by a “dynamic power splitter”, which switches the input signal at twice the local oscillator frequency between the two Gilbert cell mixers. The outputs of the mixers are not connected to a summer.

U.S. published Patent Application 2001/0027095 discloses an image reject mixer comprising two Gilbert cell mixers whose outputs are connected via phase-shifting circuits to a summer. Similarly, EP 0 998 025 discloses an image reject mixer in which the individual mixer outputs are supplied via phase shifting circuits to a summer.

### SUMMARY

One embodiment of the invention provides a frequency changer for a radio frequency tuner. The frequency changer generally includes a first mixer and a local oscillator, said first mixer comprising N first mixing stages, where N is an integer greater than 1, first signal paths providing a same first phase shift, and a first summer, said first mixing stages having outputs connected to said first summer via respective ones of said first signal paths, first signal inputs connected together and first commutating inputs connected to said local oscillator, which is arranged to supply first substantially rectangular local oscillator signals of a same frequency and of different phases to said first commutating inputs.

Another embodiment of the invention provides a frequency changer for a radio frequency tuner. The frequency changer generally includes a first mixer and a local oscillator, said first mixer comprising N first mixing stages, where N is an integer greater than 1; first signal paths providing a same first phase shift; a first summer, said first mixing stages having outputs connected to said first summer via respective ones of said first signal paths, first signal inputs connected together and first commutating inputs connected to said local oscillator, which is arranged to supply first substantially rectangular local oscillator signals of a same frequency and of different phases to said first commutating inputs; a second mixer, said second mixer comprising N second mixing stages; second signal paths providing a same second phase shift; and a second summer, said second mixing stages having outputs connected to said second summer via respective ones of said second signal paths, second signal inputs connected together and second commutating inputs connected to said local oscillator, which is arranged to supply thereto second substantially rectangular local oscillator signals of said same frequency as and substantially in phase-quadrature with respect to said first local oscillator signals.

Yet another embodiment of the invention provides for a tuner comprising a frequency changer. The frequency changer of the tuner generally includes a first mixer and a local oscillator, said first mixer comprising N first mixing stages, where N is an integer greater than 1, first signal paths providing a same first phase shift, and a first summer, said first mixing stages having outputs connected to said first summer via respective ones of said first signal paths, first signal inputs connected together and first commutating inputs connected to said local oscillator, which is arranged to supply first substantially rectangular local oscillator signals of a same frequency and of different phases to said first commutating inputs.

Yet another embodiment of the invention provides for a zero intermediate frequency (ZIF) tuner comprising a frequency changer. The frequency changer of the ZIF tuner generally includes a first mixer and a local oscillator, said first mixer comprising N first mixing stages, where N is an integer greater than 1; first signal paths providing a same first phase shift; a first summer, said first mixing stages having outputs connected to said first summer via respective ones of said first signal paths, first signal inputs connected together and first commutating inputs connected to said local oscillator, which is arranged to supply first substantially rectangular local oscillator signals of a same frequency and of different phases to said first commutating inputs; a second mixer comprising N second mixing stages; second signal paths providing a same second phase shift; and a second summer, said second mixing stages having outputs connected to said second summer via respective ones of said second signal paths, second signal inputs connected together and second commutating inputs connected to said local oscillator, which is arranged to supply thereto second substantially rectangular local oscillator signals of said same frequency as and substantially in phase-quadrature with respect to said first local oscillator signals.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block schematic diagram of a tuner according to one embodiment of the invention;

FIG. 2 is a block circuit diagram of a mixer of the tuner of FIG. 1 according to one embodiment of the invention;

FIG. 3 is a waveform diagram illustrating commutating signals supplied to the mixer of FIG. 2 according to one embodiment of the invention;

FIG. 4 is a block circuit diagram of another mixer which may be used in the tuner of FIG. 1 according to one embodiment of the invention;

FIG. 5 is a block circuit diagram of a phase difference generating stage of a local oscillator of the tuner of FIG. 1 according to one embodiment of the invention;

FIG. 6 is a block schematic diagram of a zero intermediate frequency tuner according to one embodiment of the invention; and

FIG. 7 is a block schematic diagram of a near-zero intermediate frequency tuner according to one embodiment of the invention.

Like reference numerals refer to like parts throughout the drawings.

### DETAILED DESCRIPTION

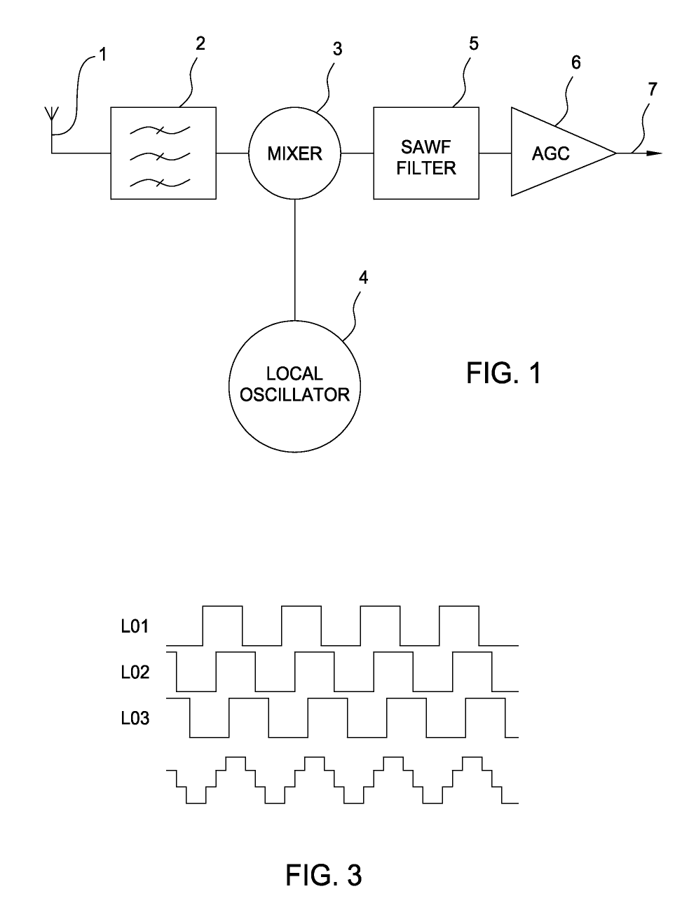

The tuner shown in FIG. 1 may be used for receiving digitally or analogically encoded signals from any distribution or broadcast medium. Examples of such media are terrestrial broadcast, satellite broadcast and cable distribution. The signals may represent any or any combination, of television, audio, telephony and data. The tuner may be of the “classical” intermediate frequency (IF) type in which any of the channels received in a broadband input signal can be selected for reception and be converted to a conventional intermediate frequency, for example, between 30 and 50 MHz. The illustrated tuner is thus of the single conversion type. However, the arrangement illustrated in FIG. 1 may form part of a dual conversion tuner. For example, this arrangement may act as a first upconverter for converting the selected desired channel to a relatively high first intermediate frequency. In the case where the spectrum of the input signal is from 50 to 860 MHz, the first intermediate frequency may be on the order of 1.1 GHz. Alternatively, in the case where a dual conversion tuner performs a fixed block upconversion of the input frequency spectrum to a higher frequency band, the arrangement shown in FIG. 1 may be used as the second converter for selecting the desired channel for reception and for converting it to any desired output intermediate frequency.

In the case of a single conversion tuner, the arrangement shown in FIG. 1 comprises an input 1 for receiving the broadband radio frequency input signal, typically comprising a plurality of channels of predetermined widths and frequency spacing. The signal may be supplied to a tracking bandpass filter 2, which is typically required to achieve an attenuation of between 20 and 30 dB for channels remote from the desired channel and including the image channel. Such a filter may be embodied within a monolithic integrated circuit in which the whole tuner is formed, and an example of a suitable filter is disclosed in British patent application no. 0511569.6. The filter 2 may be controlled in an effort to track the frequency of the presently selected channel and may typically pass this channel, and several adjacent channels, with minimal attenuation.

The output of the filter 2 may be supplied to a frequency changer, which is described in more detailed hereinafter and which may comprise a mixer 3 and a local oscillator 4. The frequency changer may convert the selected desired channel to the output intermediate frequency and supply the frequency-converted signal to a surface acoustic wave filter (SAWF) 5, which typically has a passband substantially equal to the width of the selected channel. The filter output signal may be supplied to an automatic gain control (AGC) stage 6, which provides amplification and control of gain so as to supply a substantially consistent signal level at the output 7 of the tuner. The output signal may be typically supplied to a demodulator of the appropriate type for recovering the desired signal.

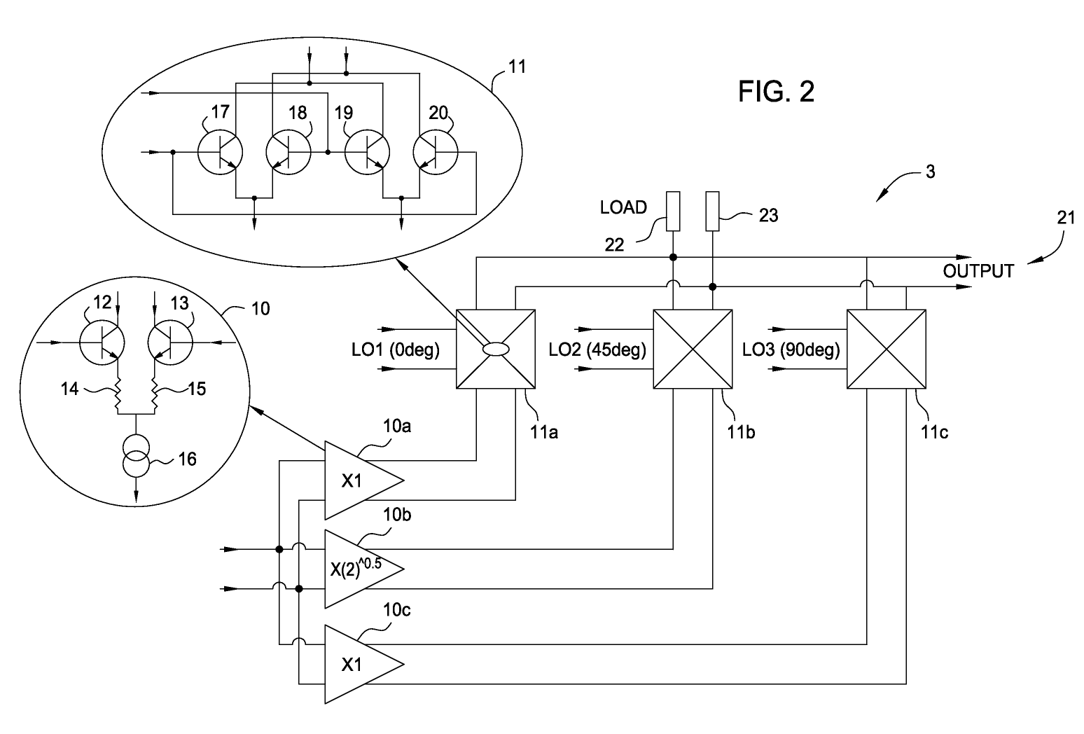

The mixer 3 is shown in more detail in FIG. 2. The mixer may comprise three mixing stages connected partially in parallel with each mixing stage being of the Gilbert cell type and comprising a transconductance stage 10a, 10b, 10c connected to a current switching cell 11a, 11b, 11c. As shown in the inset 10 in FIG. 2, each transconductance stage may comprise a long tail pair of transistors 12 and 13 provided with respective emitter degeneration resistors 14 and 15 and a common constant current source 16.

Each switching cell may be of the cross-coupled differential pair type as illustrated in the inset 11. The cell may comprise transistors 17 to 20 with the emitters of the transistors 17 and 18 being connected together and to the collector of the transistor 12 and with the emitters of the transistors 19 and 20 being connected together and to the collector of the transistor 13. The collectors of the transistors 17 and 19 may be connected together and the collectors of the transistors 18 and 20 are connected together to form differential outputs 21 of the mixer provided with a common load arrangement in the form of resistors 22 and 23. This load arrangement may be common to the three mixing stages and forms a summer which sums the outputs of the mixing stages. The outputs of the mixing stages may be connected to the summer via signal paths having the same phase shifts, which are typically substantially zero. The signal paths typically comprise the interconnections.

The bases of the transistors 17 and 20 may be connected together, and the bases of the transistors 18 and 19 may be connected together to form a differential commutating signal input of the mixer stage. The mixer stages 11a, 11b and 11c may be connected to a local oscillator phase generating output arrangement described hereinafter so that the mixing stages receive local oscillator signals LO1, LO2 and LO3 of the same frequency, but having relative phase shifts of 0°, 45° and 90°, respectively.

The differential inputs of the transconductance stages 10a, 10b and 10c may be connected together to form a differential signal input of the mixer for receiving the signals filtered by the filter 2. The transconductances (×1) of the stages 10a and 10c may be substantially equal to each other whereas the transconductance (×2^{0.5}) of the stage 10b may be equal to the product of the transconductance of each of the stages 10a and 10c and the positive square root of 2.

The top three waveforms shown in FIG. 3 illustrate the relative phases and the waveforms of the square wave local oscillator signals LO1, LO2 and LO3 supplied by the local oscillator 4 to the mixing stages of the mixer 3. The square waveform LO1 may be used as the reference and therefore, may be considered to have 0° phase shift. The square waveform LO2 should have of the same frequency as the waveform LO1, but should have a positive phase shift of 45° with respect thereto. The square waveform LO3 should have the same frequency as the waveform LO1 and should have a positive phase shift of 90° with respect thereto. The bottom waveform in FIG. 3 illustrates the waveform which would be obtained by adding the waveforms LO1, LO2 and LO3 as shown. Such a waveform has a modified harmonic spectrum such that at least some of the harmonics above the fundamental frequency have reduced levels compared with a square wave of the same frequency. This may also be thought of as the composite waveform more closely resembling a sine wave of the fundamental frequency. Thus, if such a composite waveform is used as the commutating signal in a frequency changer, the reduction in level of at least some of the harmonics compared with that of the fundamental frequency should reduce the effects of harmonic mixing whereby, as described hereinbefore, signals at higher frequencies than the selected channel are mixed to the same intermediate frequency. However, as described hereinbefore, it may be undesirable for a waveform of the type shown in the bottom graph of FIG. 3 to be used as a commutating signal because this may increase the noise figure and impair the signal handling capability of a mixer.

In the present frequency changer, the individual waveforms LO1, LO2 and LO3 may be supplied to the respective mixing stages. Each mixing stage may perform frequency conversion of the input radio frequency signal with its respective commutating signal and the frequency-changed outputs of the mixing stages 11a, 11b and 11c may be summed to form the output 21 of the mixer 3. Because of the linear nature of the process, the resulting output signal should be that which would have been obtained if the composition waveform of FIG. 3 had been applied to a single mixing stage, but without the impaired noise figure and signal handling performance of using such a composite commutating signal. Thus, the improved harmonic mixing performance which would have been obtained by the composite commutating waveform should be obtained but without degradation of the noise and intermodulation performance of the mixer.

Although three mixing stages receiving three commutating signals of different phases are illustrated, any number of mixing stages supplied by any number of different phase local oscillator signals may be used with the outputs of the mixing stages being appropriately summed so as to reduce harmonic mixing. The effective gains of each mixing stage may be chosen relative to the other gains so as to minimize harmonic mixing. In the example illustrated in FIG. 2, the different gains are provided by the transconductances of the transconductance stages 10a, 10b and 10c and are optimum for use with the commutating signal phases illustrated. By choosing these values, the third and fifth order harmonics of the local oscillator fundamental frequency may be theoretically removed, although in practice because of imbalances and component tolerances, these harmonics may be present, but at a very much reduced level. Thus, harmonic mixing with the third and fifth order harmonics may be eliminated or greatly reduced so that any signal energy or noise which would otherwise be superimposed on the output passband of the mixer by harmonic mixing may be eliminated or substantially reduced.

In practice, it may be possible to provide between 30 and 40 dB of harmonic mixing cancellation by means of this technique. In a typical application of such a tuner, a total composite cancellation of about 60 dB may be required so that the filter 2 need only provide 20 to 30 dB of suppression or attenuation in order to achieve the required figure. An “on-chip” tracking bandpass filter may achieve this so that the whole tuner may be monolithically integrated, with the exception of the SAWF 5 in the present case of a conventional IF tuner.

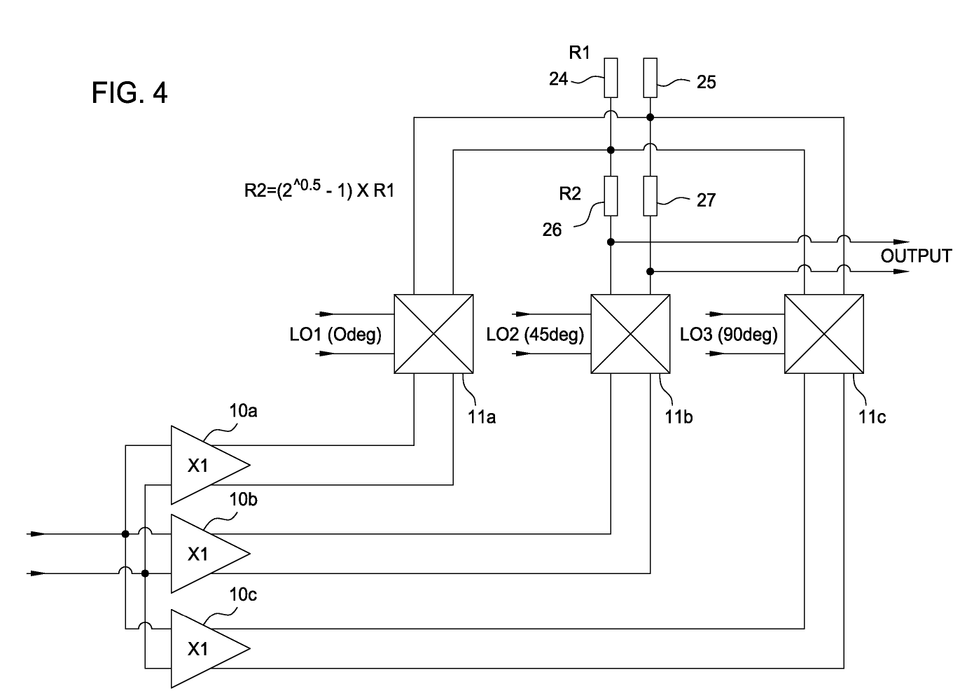

In FIG. 2, the different mixer stage gains may be provided by different transconductances in the stages 10a, 10b and 10c. FIG. 4 illustrates an alternative arrangement in which the transconductances of the stages 10a, 10b and 10c are the same and the different mixer stage gains are provided by a split common load arrangement comprising resistors 24 to 27. The resistors 24 and 25 may have the same resistance R1, and the resistors 26 and 27 may have the same resistance R2. In order to provide the desired mixer stage relative gains, the resistances R1 are R2 may be related by the expression:
R2=(\sqrt{2}−1)×R1

Such an arrangement may have advantages in reducing imbalances, and hence improving performance, caused by the different transconductances and by implementation differences for handling currents with ratios different from unity. It should also be possible to combine both techniques for providing the appropriate relative gains of the mixer stages of the mixer 3.

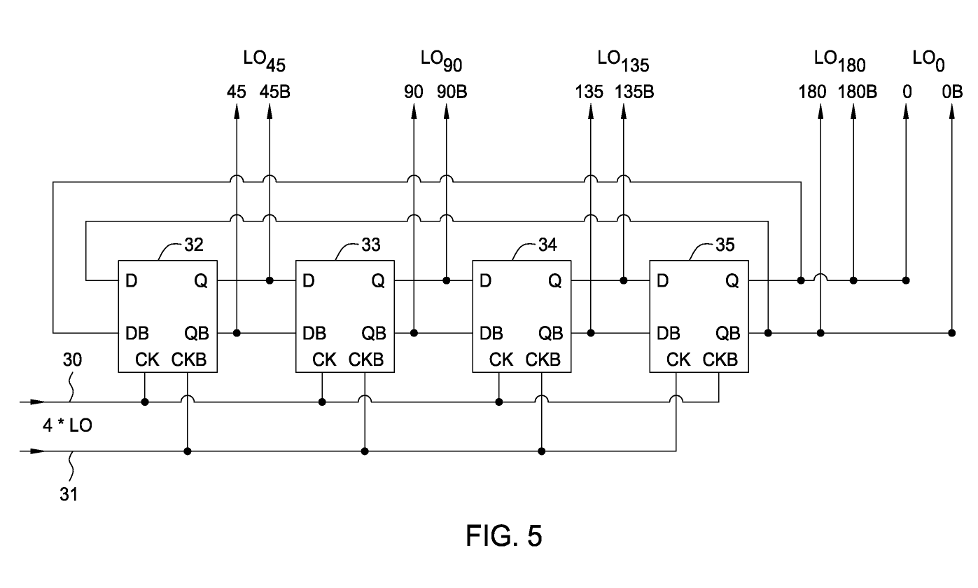

FIG. 5 illustrates the phase shift generating output stage of the local oscillator 4 for providing the phase shifts required by the mixer shown in FIG. 2. The local oscillator may be a variable frequency oscillator whose frequency is selected, by means of a phase locked loop (PLL) synthesiser, in order to convert the desired selected channel to the required intermediate frequency. It is common for the basic oscillator or clock in a local oscillator to operate at a multiple of the actual required local oscillator frequency. In the arrangement illustrated in FIG. 5, the basic oscillator may run at a frequency of four times the required local oscillator output frequency, and differential connections 30 and 31 may supply this as a differential clock signal to direct and complementary or inverted clock inputs CK, CKB of four D-type flip-flops 32 to 35. The flip-flops 32 to 35 may be connected together as a divide-by-four ring counter, with the direct and inverted outputs Q and QB of the flip-flops 32 to 34 being connected to the direct and inverted inputs D and DB, respectively, of the flip-flops 33 to 35 and with the direct and inverted outputs Q and QB of the flip-flop 35 being connected to the inverted and direct data inputs DB and D, respectively, of the flip-flop 32. The outputs of the flip-flops 32 to 35 may provide local oscillator outputs signals with phase-shifts of 45°, 90°, 135° and 0°, respectively. By reversing the connections to the outputs of the flip-flop 35, a local oscillator signal with a phase shift of 180° may be provided. Thus, the output stage 5 may provide all of the local oscillator signals required by the mixers shown in FIGS. 2 and 4.

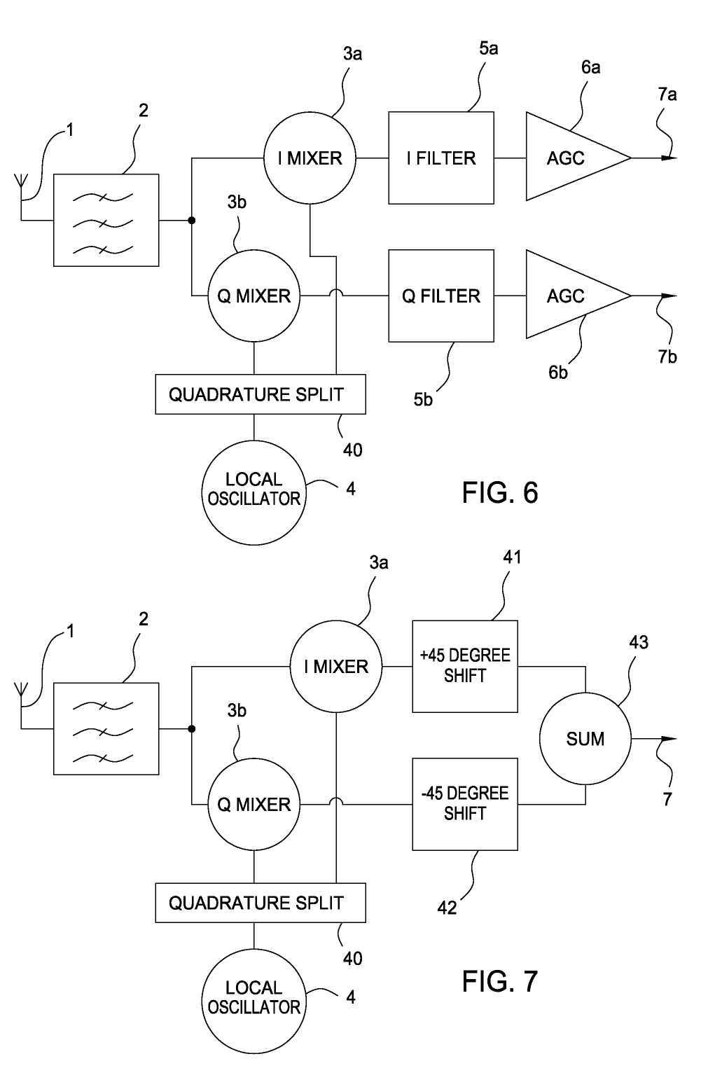

FIG. 6 illustrates a tuner of the zero intermediate frequency (ZIF) type providing direct conversion of the selected channel to baseband in-phase (I) and quadrature (Q) components or data streams. The tuner may have an input 1 and a tracking radio frequency filter 2 of the type illustrated in FIG. 2. However, the output of the filter 2 may be supplied to the signal inputs of two mixers 3a and 3b for providing the I and Q components, respectively.

Each of the mixers 3a and 3b may have the structure illustrated in FIG. 2 or FIG. 4 comprising multiple (in this case three) mixer stages connected in parallel and receiving local oscillator signals of the same frequency, but of different phases. FIG. 6 illustrates a local oscillator 4 and a quadrature splitter 40 designed such that the I mixer 3a may receive local oscillator signals of relative phases 0°, 45° and 90° whereas the Q mixer 3b may receive local oscillator signals in quadrature with respect to those supplied to the mixer 3a and thus, having relative phases of 90°, 135° and 180°. The local oscillator 4 and the quadrature splitter may be embodied as described hereinbefore with reference to FIG. 5. In particular, the ring counter output arrangement of the local oscillator illustrated in FIG. 5 may provide local oscillator signals of all the necessary phases to supply the mixers 3a and 3b.

The I and Q baseband signals from the mixers 3a and 3b may be supplied to filters 5a and 5b for performing channel filtering. Because the I and Q signals are at baseband, the filters 5a and 5b may typically be low pass filters having a passband substantially equal to half the channel bandwidth so as to pass the desired signals at baseband while rejecting or greatly attenuating all other channels including adjacent channels converted by the mixers 3a and 3b. The filtered baseband signals may then be supplied via respective AGC stages 6a and 6b of the same type as the stage 6 shown in FIG. 1 to I and Q outputs 7a and 7b of the tuner.

FIG. 7 illustrates a tuner including an image reject mixer for providing rejection or attenuation of the image channel. The tuner is intended for use as a near zero intermediate frequency (NZIF) tuner in order to provide rejection or attenuation of the image channel, which is immediately adjacent the desired channel in NZIF tuners, and hence may be difficult to attenuate by practical filtering. However, image reject frequency changers may also be used in tuners providing conventional intermediate frequency outputs.

The tracking filter and the quadrature frequency changer comprising the mixers 3a, 3b, the local oscillator 4 and the quadrature splitter 40 may be of the same type as described with reference to FIG. 6. However, whereas the commutating signals supplied to the mixers 3a and 3b in the ZIF tuner of FIG. 6 may have fundamental frequencies at the center of the desired channel, the commutating signals supplied to the mixers 3a and 3b in the tuner of FIG. 7 may be substantially at one end of the frequency band occupied by the desired channel.

The outputs of the mixers 3a and 3b may be supplied to phase shifting stages 41 and 42. In the embodiment illustrated in FIG. 7, the stages 41 and 42 provide +45° and −45° phase shift. However, any phase shifting arrangement may be provided which provides a relative phase shift of 90°. Also, although the stages 41 and 42 are shown as being disposed after the mixers 3a and 3b, these stages may be disposed ahead of the mixers, but may then be required to provide the relative phase shift at the actual frequency of any desired channel in the broadband input signal.

The outputs of the stages 41 and 42 may be supplied to a summer 43 which forms the sum of the input signals. The phase shifts applied to the signals may be such that the desired channel is “constructed,” whereas the image channel is suppressed or at least sufficiently attenuated so as not to interfere with reception of the desired channel. The stages 41 and 42 may also provide filtering to remove or greatly attenuate other undesired channels from the signals supplied to the summer 43. The output of the summer 43 may therefore supply the desired channel at the tuner output 7.

It is thus possible to provide arrangements in which contamination or interference caused by harmonic mixing is substantially reduced while retaining the noise and signal handling performance associated with hard switching commutating signals. It is possible to embody most or all of such tuners in a single monolithically integrated circuit so as to simplify manufacture and reduce cost. Imbalance between quadrature channels in quadrature mixing embodiments may also be reduced, for example by the use of commonly generated signals for both mixers as illustrated in FIG. 5.

While the foregoing is directed to embodiments of the present invention, other and further embodiments of the invention may be devised without departing from the basic scope thereof, and the scope thereof is determined by the claims that follow.

What is claimed is:

1. A frequency changer for a radio frequency tuner, comprising:
a first mixer; and
a local oscillator, said first mixer comprising N first mixing stages, where N is an integer greater than 1, first signal paths providing a same first phase shift, and a first summer, said first mixing stages having outputs connected to said first summer via respective ones of said first signal paths, first signal inputs connected together and first commutating inputs connected to said local oscillator, which is arranged to supply first substantially rectangular local oscillator signals of a same frequency and of different phases to said first commutating inputs.

2. The frequency changer of claim 1, wherein said same first phase shift is a substantially zero phase shift.

3. The frequency changer of claim 1, wherein each of said first mixing stages comprises a Gilbert cell.

4. The frequency changer of claim 1, wherein said first mixing stages have at least two different gains.

5. The frequency changer of claim 4, wherein said first mixing stages include transconductance stages having at least two different transconductances.

6. The frequency changer of claim 5, wherein said first summer comprises a common output load arrangement of said first mixing stages.

7. The frequency changer of claim 4, wherein said first summer comprises a partially common load arrangement of said first mixing stages.

8. The frequency changer of claim 1, wherein said local oscillator is a variable frequency oscillator.

9. The frequency changer of claim 8, in which said local oscillator is arranged to provide a tuning range greater than one octave.

10. The frequency changer of claim 1, wherein said local oscillator comprises a divide-by-M phase difference generating stage, where M is an integer greater than 2.

11. The frequency changer of claim 10, wherein said phase difference generating stage comprises a ring counter.

12. The frequency changer of claim 1, wherein a maximum phase difference between said first local oscillator signals is less than 180°.

13. The frequency changer of claim 12, wherein said maximum phase difference between said first local oscillator signals is less than or equal to 90°

14. The frequency changer of claim 1, wherein N is greater than 2.

15. The frequency changer of claim 14, wherein N is equal to 3.

16. The frequency changer of claim 15, wherein said first local oscillator signals have relative phases of 0°, 45° and 90°.

17. The frequency changer of claim 1, further comprising:
a second mixer, said second mixer comprising N second mixing stages;
second signal paths providing a same second phase shift; and
a second summer, said second mixing stages having outputs connected to said second summer via respective ones of said second signal paths, second signal inputs connected together and second commutating inputs connected to said local oscillator, which is arranged to supply thereto second substantially rectangular local oscillator signals of said same frequency as and substantially in phase-quadrature with respect to said first local oscillator signals.

18. The frequency changer of claim 17, wherein said same second phase shift is a substantially zero phase shift.

19. The frequency changer of claim 17, wherein said first local oscillator signals have relative phases of 0°, 45° and 90° and said second local oscillator signals have relative phases of 90°, 135° and 180°.

20. The frequency changer of claim 17, wherein said second mixer is substantially identical to said first mixer.

21. A tuner comprising:
a frequency changer, comprising:
a first mixer, and a local oscillator, said first mixer comprising N first mixing stages, where N is an integer greater than 1:
first signal paths providing a same first phase shift: and
a first summer, said first mixing stages having outputs connected to said first summer via respective ones of said first signal paths, first signal inputs connected together and first commutating inputs connected to said local oscillator, which is arranged to supply first substantially rectangular local oscillator signals of a same frequency and of different phases to said first commutating inputs.

22. The tuner of claim 21, further comprising a tracking radio frequency filter ahead of said frequency changer.

23. The tuner of claim 21, further comprising a zero intermediate frequency (ZIF) tuner, and wherein said frequency changer comprises:
a second mixer comprising N second mixing stages;
second signal paths providing a same second phase shift; and
a second summer, said second mixing stages having outputs connected to said second summer via respective ones of said second signal paths, second signal inputs connected together and second commutating inputs connected to said local oscillator, which is arranged to supply thereto second substantially rectangular local oscillator signals of said same frequency as and substantially in phase-quadrature with respect to said first local oscillator signals.

24. The tuner of claim 21, wherein said frequency changer is an image cancelling frequency changer comprising:
a second mixer comprising N second mixing stages;
second signal paths providing a same second phase shift; and
a second summer, said second mixing stages having outputs connected to said second summer via respective ones of said second signal paths, second signal inputs connected together and second commutating inputs connected to said local oscillator, which is arranged to supply thereto second substantially rectangular local oscillator signals of said same frequency as and substantially in phase-quadrature with respect to said first local oscillator signals.

25. The tuner of claim 24, further comprising a third summer and third and fourth signal paths connected to said third summer and providing a relative phase shift of 90°, said first and second mixers being disposed in said third and fourth signal paths, respectively.

26. The tuner of claim 24, further comprising a near-zero intermediate frequency (NZIF) tuner.
